(19) United States
(12) Patent Application Publication
(10) Pub. No.: US 2006/0165244 A1
(43) Pub. Date: Jul. 27, 2006

(54) Computer system for switching audio outputs and method thereof

(76) Inventor: Chao-Hung Wu, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/010,358

(22) Filed: Dec. 14, 2004

(51) Int. Cl. H04B 3/00; H02B 1/00

(52) U.S. Cl. 381/77; 381/123; 381/58

(57) ABSTRACT

A computer system for switching audio outputs and a method thereof are provided. The computer system includes a host, a speaker, an earphone, and a switch controller for selectively switching one of the speaker and the earphone to electrically connect to an audio port of the host. The switch controller includes a first jack for connecting to the speaker, a second jack for connecting to the earphone, a third jack for connecting to the audio port of the host through a cable, and a switch. The switch can be switched so that the first jack and the third jack are electrically connected, and hence the audio signals are outputted to the speaker. Alternatively, the switch can be switched so that the second jack and the third jack are electrically connected, and hence the audio signals are outputted to the earphone.

### BACKGROUND OF THE INVENTION

1. Field of the Invention

The present invention relates to a computer system and, more particularly, relates to a computer system for selectively outputting audio signals to a speaker or an earphone via a switch.

2. Description of Related Art

All computer peripherals on the current market are designed detachable from computers. Some of them, such as speakers, earphones, microphones and web cameras, can operate together to make computers to execute applications associated with video and audio signals or to execute real-time communication applications through the Internet. Computers are therefore capable of transmitting video and audio signals.

FIGS. 1 and 2 show two of the solutions for a computer to output audio signals. Referring to FIG. 1, a computer host 7 is connected to a speaker 81 and a microphone 82 through a speaker port 71 and a microphone port 72 respectively. The audio signals from the computer host 7 may be outputted via the speaker 81 so that anyone nearby can hear the sound. Referring to FIG. 2, the computer host 7 is connected to a headset 83 through the speaker port 71 and the microphone port 72. The audio signals from the computer host 7 may be hence outputted via the earphone of the headset 83 and only the user wearing the headset 83 can hear the sound.

The aforementioned two solutions have their own advantages and disadvantages respectively. For the solution shown in FIG. 1, it prevents user's ears from getting uncomfortable caused by wearing the earphone for a long time, but other people around the user might be disturbed or might be aware of your privacy because the speaker 81 speaks to the public. For the solution shown in FIG. 2, it provides a private way to communicate in contrast to the solution shown in FIG. 1. Other people around you would not be disturbed, but the headset 83 needs wearing all the time. If not, users might miss a call or a message.

Even though a speaker and an earphone can be connected to a computer at the same time to avoid frequently plugging and unplugging, users still need to selectively disconnect either one for a particular purpose by themselves. It is still inconvenient.

### SUMMARY OF THE INVENTION

The main aspect of the present invention is to provide a computer system for switching audio outputs and a method thereof, which can selectively transmit audio signals from a computer to either a speaker or an earphone without plugging or unplugging cables.

To achieve the above aspect, the present invention provides a computer system for switching audio outputs. It includes a host, a speaker, an earphone, and a switch controller for selectively switching one of the speaker and the earphone to electrically connect to an audio port of the host. The audio signals from the computer may be thereby outputted to the speaker or the earphone by simply switching the switch controller.

The switch controller of the above-mentioned computer system includes a first jack connected to the speaker, a second jack connected to the earphone, a third jack connected to the audio port of the host through a cable, and a switch for selectively switching one of the first jack and the second jack to electrically connect to the third jack.

To achieve the above aspect, the present invention provides a method for a computer system to switch audio outputs. The computer system includes a host outputting audio outputs to a speaker or an earphone by switching. The method includes the steps of: providing a switch controller, the switch controller having a first jack, a second jack, a third jack, and a switch, wherein the switch selectively switches one of the first jack and the second jack to electrically connect to the third jack; connecting the speaker to the first jack; connecting the earphone to the second jack; connecting an audio port of the host to the third jack through a cable; and selectively controlling the switch to transmit audio signals from the host to the speaker or the earphone.

To make the Examiner understand the characteristics and technical disclosures of the present invention clearly, please refer to the following detailed description and the drawings. It is noted that the drawings are expected for the purpose of reference and illustration but not expected for the purpose of restricting the scope of the present invention.

### BRIEF DESCRIPTION OF THE DRAWINGS

FIG. 1 illustrates the connection of a computer of the prior art to a speaker and a microphone;

FIG. 2 illustrates the connection of a computer of the prior art to a headset;

FIG. 3 illustrates an embodiment of the present invention, in which a computer outputs audio signals to a speaker; and

FIG. 4 illustrates another embodiment of the present invention, in which a computer outputs audio signals to a headset.

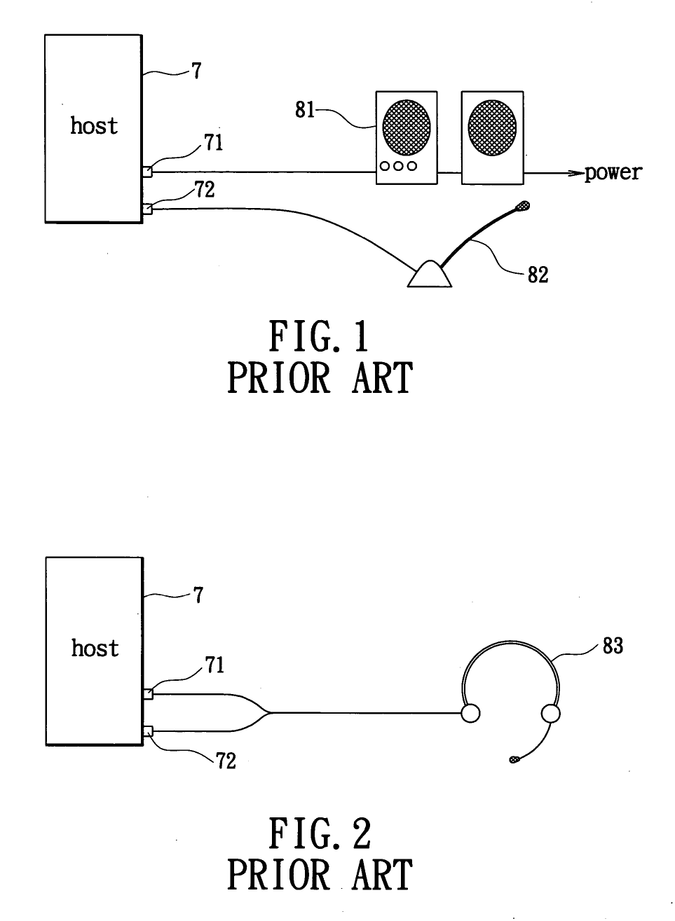

### DETAILED DESCRIPTION OF THE PREFERRED EMBODIMENTS

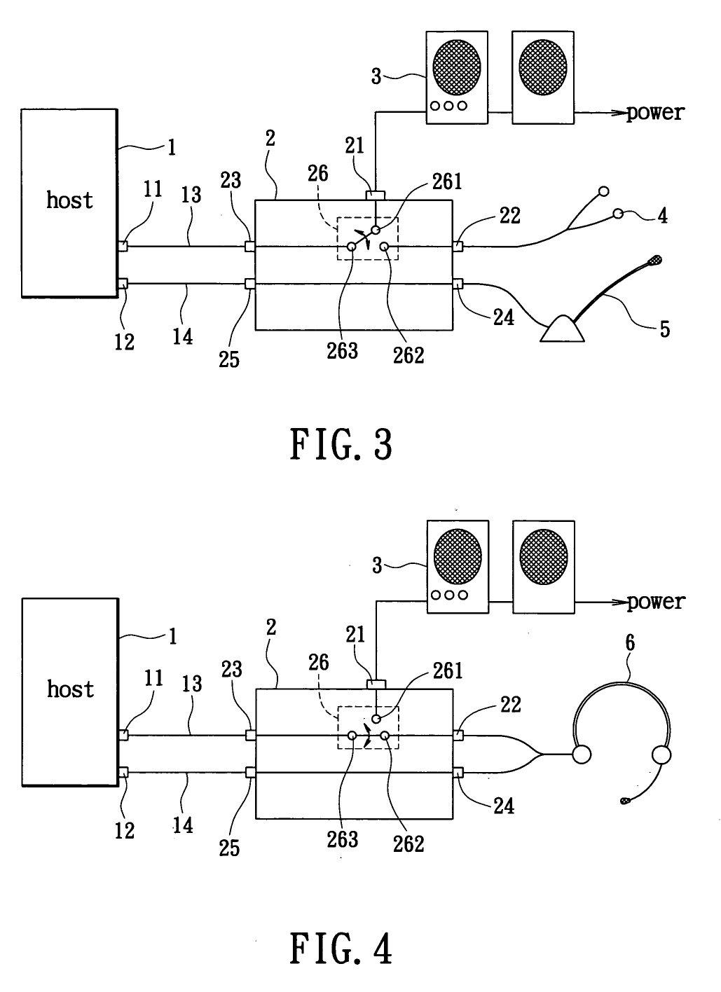

FIG. 3 shows an embodiment of the present invention, in which a host transmits audio signals to a speaker. The present invention discloses a computer system for switching audio outputs and includes a host 1, a switch controller 2, a speaker 3, an earphone 4, and a microphone 5. The switch controller 2 is configured to selectively switch one of the speaker 3 and the earphone 4 to electrically connect to an audio port 11 of the host 1 so that audio signals from the host 1 are able to be outputted to either the speaker 3 or the earphone 4 by switching.

The switch controller 2 includes a first jack 21, a second jack 22, a third jack 23, a fourth jack 24, a fifth jack 25 and a switch 26. The switch 26 is configured to selectively switch one of the first jack 21 and the second jack 22 to electrically connect to the third jack 23. The switch 26 has a first contact point 261 for electrically connecting to the first jack 21, a second contact point 262 for electrically connecting to the second jack 22, and a third contact point 263 for electrically connecting to the third jack 23. As FIG. 3 shows, the switch 26 is switched to a particular position so that the first contact point 261 and the third contact point 263 are electrically connected, and the fourth jack 24 and the fifth jack 25 are directly electrically connected together.

The speaker 3 is connected to the first jack 21 of the switch controller 2. The earphone 4 is connected to the second jack 22. The microphone 5 is connected to the fourth jack 24. The third jack 23 of the switch controller 2 is connected to the audio port 11 of the host 1 through a cable 13. The fifth jack 25 is connected to a microphone port 12 of the host 1 through a cable 14. Therefore, audio signals can be transmitted from the host 1 to the speaker 3 and, moreover, audio signals are able to be transmitted from the microphone 5 to the host 1 through the switch controller 2.

FIG. 4 shows another embodiment of the present invention, in which a host transmits audio signals to a headset. The major difference between the embodiments of FIGS. 3 and 4 is that the earphone 4 and the microphone 5 (FIG. 3) are substituted by a headset 6 (FIG. 4). These two connection ways are both able to be embodied in the present invention. The earphone cable of the headset 6 is connected to the second jack 22 and the microphone cable of the headset 6 is connected to the fourth jack 24. The switch 26 of FIG. 4 is now switched to the other position so that the second contact point 262 and the third contact point 263 are electrically connected. Audio signals from the host 1 hence can be transmitted to the earphone element of the headset 6.

Accordingly, the present invention can control audio signals from the host 1 transmitting to the speaker 3 or the earphone 4, just by switching the switch 26, without plugging or unplugging cables repeatedly. It also provides a more convenient and prompter way to output audio signals via the speaker 3 or the earphone 4. For example, when a user has a chat on the Internet by using a communication application and the chat is associated with privacy and confidence, the user may switch the voice to the earphone 4 by the switch 26 to prevent other people from listening. Otherwise, the user may switch the voice to the speaker 3 by the switch 26 to avoid uncomfortableness resulting from wearing the earphone for a long time or to avoid missing any calls from the communication application due to not wearing the earphone.

The above description of the embodiments is expected to clearly expound the characteristics of the present invention but not expected to restrict the scope of the present invention. Those skilled in the art will readily observe that numerous modifications and alterations may be made while retaining the teaching of the invention. Accordingly, the above disclosure should be construed as limited only by the bounds of the claims.

What is claimed is:

1. A computer system for switching audio outputs, comprising:
a host;
a speaker;
an earphone; and
a switch controller for selectively switching one of the speaker and the earphone to electrically connect to an audio port of the host.

2. The computer system of claim 1, wherein the switch controller comprises:
a first jack connected to the speaker;
a second jack connected to the earphone;
a third jack connected to the audio port through a cable; and
a switch for selectively switching one of the first jack and the second jack to electrically connect to the third jack.

3. The computer system of claim 2, wherein the switch controller further comprises:
a fourth jack; and
a fifth jack electrically connected to the fourth jack.

4. The computer system of claim 3, wherein the fourth jack is connected to a microphone and the fifth jack is connected to a microphone port of the host through another cable.

5. The computer system of claim 4, wherein the microphone and the earphone are assembled in one set.

6. A switch controller, comprising:
a first jack;
a second jack;
a third jack; and
a switch for selectively switching one of the first jack and the second jack to electrically connect to the third jack.

7. The switch controller of claim 6, wherein the switch controller further comprises:
a fourth jack; and
a fifth jack electrically connected to the fourth jack.

8. A method for a computer system to switch audio outputs, the computer system comprising a host, the audio outputs comprising a speaker and an earphone, the method comprising providing a switch for selectively switching one of the speaker and the earphone to electrically connect to an audio port of the host to output audio signals from the host.

9. A method for a computer system to switch audio outputs, the computer system comprising a host for switching the audio outputs to a speaker and an earphone, the method comprising:
providing a switch controller, the switch controller having a first jack, a second jack, a third jack, and a switch, wherein the switch selectively switches one of the first jack and the second jack to electrically connect to the third jack;
connecting the speaker to the first jack;
connecting the earphone to the second jack;
connecting an audio port of the host to the third jack through a cable; and
controlling the switch to selectively transmit audio signals from the host to the speaker or the earphone.

10. The method of claim 9, wherein the switch controller further has a fourth jack and a fifth jack connected to each other.

11. The method of claim 10, wherein the fourth jack is connected to a microphone and the fifth jack is connected to a microphone port of the host through another cable.

12. The method of claim 11, wherein the microphone and the earphone are assembled in one set.
